(19) United States
(12) Patent Application Publication
(10) Pub. No.: US 2026/0241215 A1
(43) Pub. Date: Aug. 20, 2026

(54) ATTACHING ACCESSORIES TO FIREFIGHTING VEHICLES

(71) Applicant: Howe & Howe Inc., Waterboro, ME (US)

(72) Inventors: Matthew Gregory Williams, Kennebunk, ME (US); Timothy Merlin Foley, Lyman, ME (US); Jesse Morrill, Standish, ME (US); Michael J. Zagorianakos, Buxton, ME (US); Keith Boissonneault, Lyman, ME (US)

(21) Appl. No.: 19/644,296

(22) Filed: Apr. 10, 2026

Related U.S. Application Data
(63) Continuation-in-part of application No. 18/810,945, filed on Aug. 21, 2024.
(60) Provisional application No. 63/830,203, filed on Jun. 25, 2025.

(51) Int. Cl. A62C 27/00; A62C 99/00; B60D 1/18

(52) U.S. Cl. CPC A62C 27/00; A62C 99/009; B60D 1/187

(57) ABSTRACT

A vehicle accessory assembly includes a first vehicle accessory and a second vehicle accessory. The first vehicle accessory includes a vehicle interface constructed and arranged to attach to a vehicle, first equipment coupled with the vehicle interface, and a receiver coupled with at least one of the equipment and the vehicle interface. The first equipment is constructed and arranged to operate while the first vehicle accessory is attached to the vehicle. The receiver is constructed and arranged to support attachment of a second vehicle accessory. The second vehicle accessory includes an insert constructed and arranged to engage with the receiver of the first vehicle accessory, and second equipment coupled with the vehicle interface, the second equipment being constructed and arranged to operate while the insert of the second vehicle accessory engages with the receiver of the first vehicle accessory.

### CROSS REFERENCE TO RELATED APPLICATIONS

This application is a continuation-in-part application based on earlier-filed U.S. Application No. 18/810,945 filed on August 21, 2024, entitled "Attaching Accessories to Firefighting Vehicles", the contents and teachings of which are hereby incorporated by reference in their entirety.

Additionally, this application is based on earlier-filed U.S. Application No. 63/830,203 filed on June 25, 2025, entitled "Attaching Accessories to Firefighting Vehicles", the contents and teachings of which are hereby incorporated by reference in their entirety.

### BACKGROUND

Firefighting robotic vehicles have been used in dangerous situations to assist human firefighters in extinguishing and preventing the spread of fires. Such robots can enter hot, smoke-filled areas, even when open flames are present, and can direct large amounts of water at burning objects at very high speed.

Such a firefighting robotic vehicle may be equipped with an accessory. For example, the firefighting robotic vehicle may have a receiver enabling attachment of the accessory.

### BRIEF DESCRIPTION OF THE DRAWINGS

The foregoing and other objects, features and advantages will be apparent from the following description of particular embodiments of the present disclosure, as illustrated in the accompanying drawings in which like reference characters refer to the same parts throughout the different views. The drawings are not necessarily to scale, emphasis instead being placed upon illustrating the principles of various embodiments of the present disclosure.

FIG. 1 is a perspective view of a firefighting robotic vehicle which includes an example vehicle accessory having an auxiliary receiver in accordance with certain embodiments.

FIG. 2 is another perspective view of the firefighting robotic vehicle in accordance with certain embodiments.

FIG. 3 is a perspective view of a portion of the firefighting robotic vehicle in accordance with certain embodiments.

FIG. 4 is another perspective view of a portion of the firefighting robotic vehicle in accordance with certain embodiments.

FIG. 5 is a perspective view showing the example vehicle accessory separated from the vehicle body of the firefighting robotic vehicle in accordance with certain embodiments.

FIG. 6 is a perspective view of the example vehicle accessory in accordance with certain embodiments.

FIG. 7 is another perspective view of the example vehicle accessory in accordance with certain embodiments.

FIG. 8 is a perspective view showing partial engagement of the example vehicle accessory in accordance with certain embodiments.

FIG. 9 is another perspective view showing full engagement of the example vehicle accessory in accordance with certain embodiments.

FIG. 10 is a perspective view of an attachment assembly of the example vehicle accessory in accordance with certain embodiments.

FIG. 11 is another perspective view of the attachment assembly of the example vehicle accessory in accordance with certain embodiments.

FIG. 12 is a perspective view showing the example vehicle accessory separated from the vehicle body of the firefighting robotic vehicle and an auxiliary accessory separated from the example vehicle accessory in accordance with certain embodiments.

FIG. 13 is a detailed perspective view showing the firefighting robotic vehicle, the example vehicle accessory, and the auxiliary accessory in accordance with certain embodiments.

FIG. 14 is a perspective view of a vehicle accessory assembly for a firefighting robotic vehicle in accordance with certain embodiments.

FIG. 15 is another perspective view of the vehicle accessory assembly for the firefighting robotic vehicle in accordance with certain embodiments.

FIG. 16 is a perspective view of a firefighting robotic vehicle having the vehicle accessory assembly in accordance with certain embodiments.

FIG. 17 is a partially exploded view of the firefighting robotic vehicle having the vehicle accessory assembly in accordance with certain embodiments.

FIG. 18 is another partially exploded view of the firefighting robotic vehicle having the vehicle accessory assembly in accordance with certain embodiments.

FIG. 19 is a side view of the firefighting robotic vehicle having the vehicle accessory assembly in accordance with certain embodiments.

### DETAILED DESCRIPTION

Sometimes, it may be desirable to attach an accessory to a firefighting robotic vehicle. Along these lines, the accessory may enhance or augment operation of the firefighting robotic vehicle.

One example of an accessory is a winch having a tube which installs into a receiver of the firefighting robotic vehicle. Once the tube of the winch is installed into the receiver, the winch is able to pull (or tow) objects from behind the firefighting robotic vehicle.

Another example of an accessory is a hose manager having a tube which installs into the receiver of the firefighting robotic vehicle. Once the tube of the hose manager is installed into the receiver, the hose manager is able to guide connected hoses away from the lower rear of the firefighting robotic vehicle (e.g., to prevent the firefighting robotic vehicle from inadvertently running over and/or damaging the hoses).

Unfortunately, installing one accessory onto the firefighting robotic vehicle prevents another accessory from being installed. For example, once the winch is installed onto the firefighting robotic vehicle, the receiver is now occupied and the hose manager cannot be installed. Moreover, such firefighting robotic vehicles are typically densely populated with componentry, gear, apparatus, etc. such that there is little to no extra space available for attaching another accessory. What is needed, therefore, is a way of attaching multiple accessories to a firefighting robotic vehicle in a manner that consumes little to no extra space.

The above need is addressed at least in part by an improved technique for attaching accessories to a firefighting vehicle. The technique involves attaching, to a vehicle receiver of the firefighting vehicle, a vehicle accessory which has an auxiliary receiver. With the auxiliary receiver, yet another accessory may be attached to the firefighting vehicle. In some arrangements, the vehicle accessory is a winch attachment onto which an auxiliary accessory attaches (e.g., a hose manager, a platform or shelf, an electronic device, combinations thereof, etc.). Accordingly, multiple accessories may be attached to a firefighting robotic vehicle in a manner that consumes little to no extra space.

Alternatively or additionally, a vehicle accessory assembly may attach to a front of the firefighting vehicle in a similar manner. Along these lines and in accordance with certain embodiments, a vehicle accessory assembly which has multiple vehicle accessories attaches to a front of the firefighting vehicle. Such a feature advantageously provides convenient multi-accessory access at the front of the firefighting vehicle. For example, a plowing device may attach directly to the firefighting vehicle via a first interface, and a winch attachment may attach to the plowing device via a second interface, thus enabling the plowing device to anchor the firefighting vehicle while the winch attachment operates.

The various individual features of the particular arrangements, configurations, and embodiments disclosed herein can be combined in any desired manner that makes technological sense. Additionally, such features are hereby combined in this manner to form all possible combinations, variants and permutations except to the extent that such combinations, variants and/or permutations have been expressly excluded or are impractical. Support for such combinations, variants and permutations is considered to exist in this document.

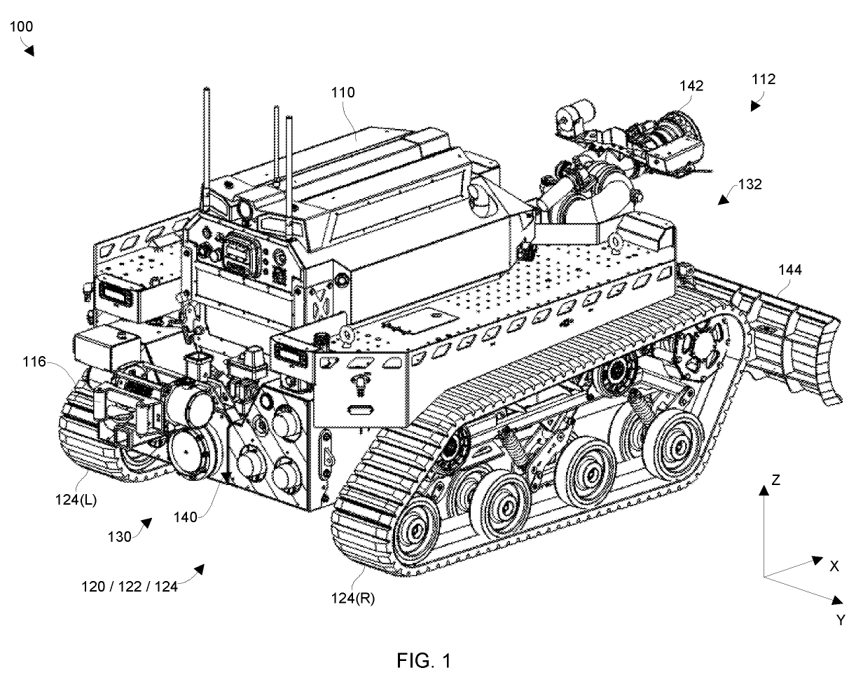

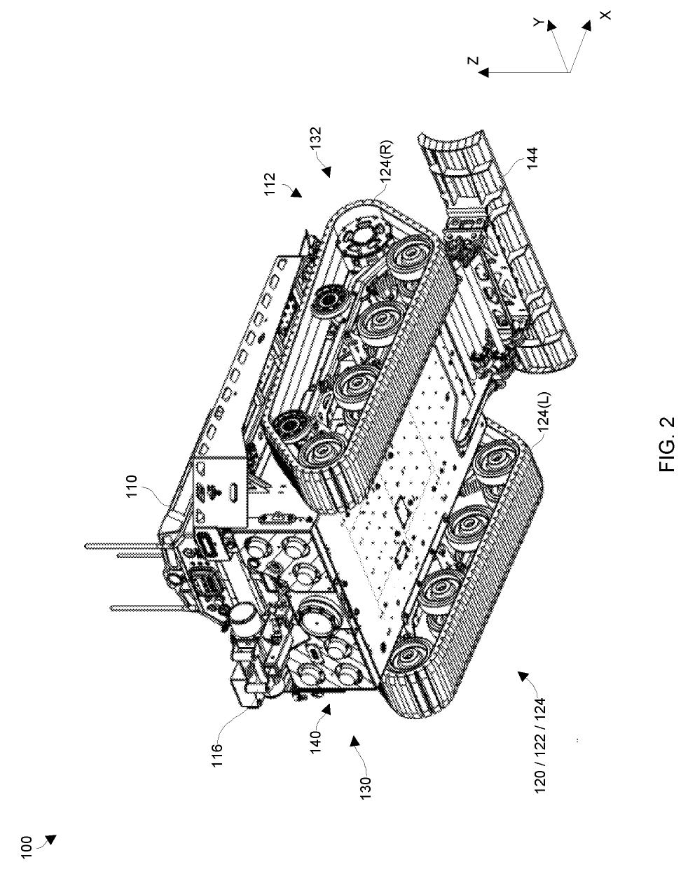

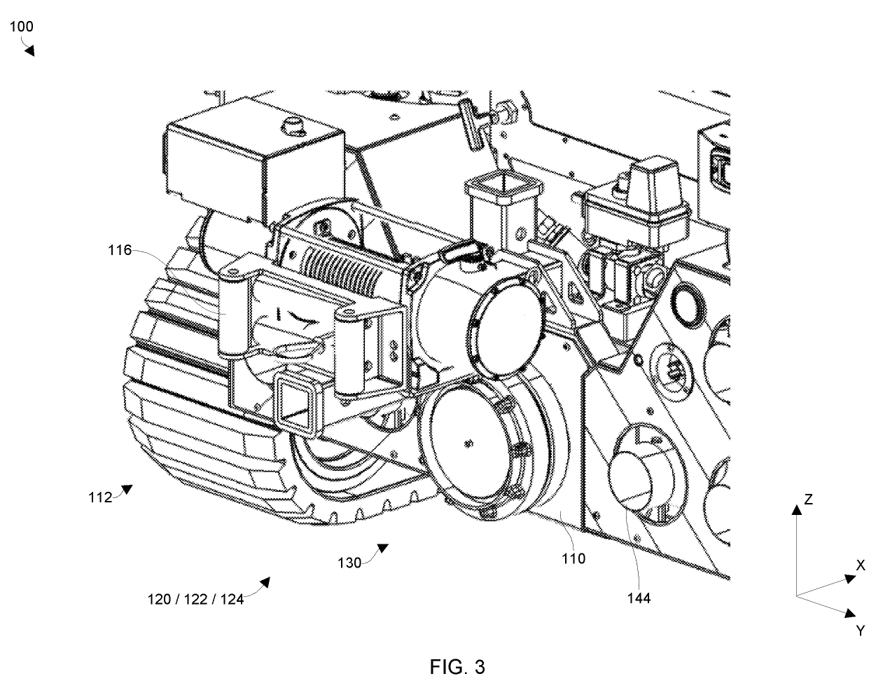

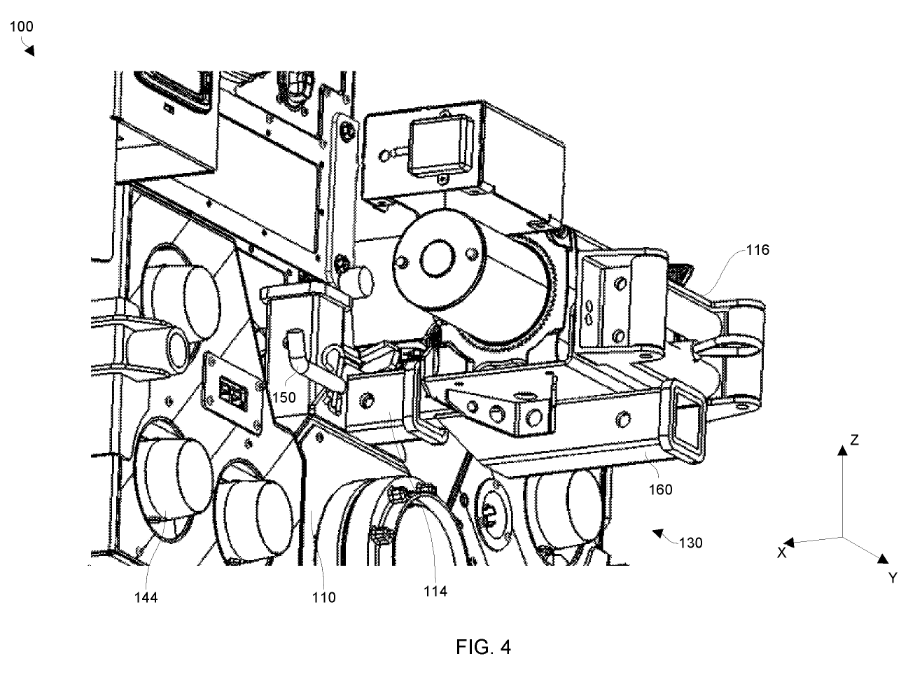

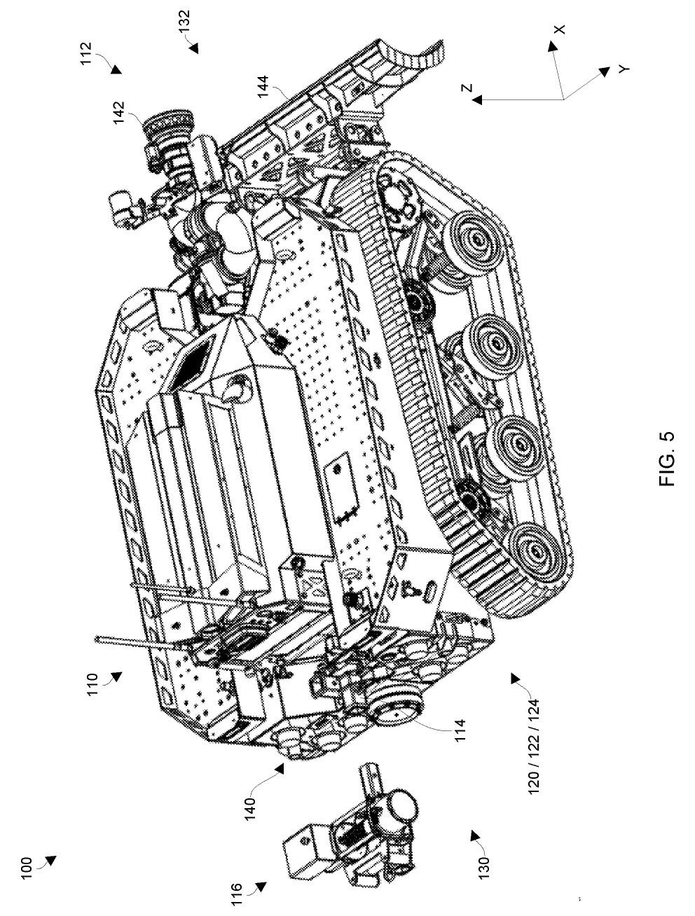

FIGS. 1 through 5 show a firefighting robotic vehicle 100 which includes an example vehicle accessory having an auxiliary receiver in accordance with certain embodiments. FIG. 1 is a perspective view of the firefighting robotic vehicle 100. FIG. 2 is another perspective view of the firefighting robotic vehicle 100. FIG. 3 is a perspective view of a portion of the firefighting robotic vehicle 100. FIG. 4 is another perspective view of a portion of the firefighting robotic vehicle 100. FIG. 5 is a perspective view showing the example vehicle accessory separated from a vehicle body of the firefighting robotic vehicle 100.

The firefighting robotic vehicle 100 is constructed and arranged to connect with a set of fluid sources (e.g., by connecting with one or more hoses leading to the set of fluid sources), move over a ground surface based on remote commands (e.g., in response to wireless signals from a base station), and deploy fluid from the set of fluid sources toward a target in response to remote commands (e.g., spray the fluid onto a burning structure). Such a firefighting robotic vehicle 100 has the ability to withstand environments that are too hazardous for human personnel.

As shown in FIGS. 1 through 5, the firefighting robotic vehicle 100 includes a firefighting vehicle body 110, firefighting equipment 112, a vehicle receiver 114, and a vehicle accessory 116.

The firefighting vehicle body 110 is constructed and arranged to perform a variety of operations. Along these lines, the vehicle body 110 supports a robotically controlled propulsion system 120 and a set of ground engaging members 122.

In response to remote commands, the robotically controlled propulsion system 120 drives the set of ground engaging members 122 to maneuver the firefighting robotic vehicle 100 over a ground surface. In some arrangements, the set of ground engaging members 122 includes a left track 124(L) and a right track 124(R) (collectively, tracks 124) which are driven by a set of wheels and motors (or engines) to enable the vehicle 100 to easily traverse a variety of different terrains which may be smooth, rough, hilly, uneven, irregular, etc. (e.g., roads, fields, sand, hills, ditches, rocky areas, uneven slopes, outcrops, creeks, marshes, combinations thereof, and so on).

The firefighting vehicle body 110 is further constructed and arranged to support the firefighting equipment 112. In some embodiments, the firefighting equipment 112 includes a set of fluid conduits, such as one or more pipes (e.g., a single conduit or multiple conduits which may be stacked vertically and/or arranged side-by-side), running from a rear 130 of the vehicle body 110 to a front 132 of the vehicle body 110.

The firefighting equipment 134 may further include a set of fluid couplings 140 at the rear 130 of the vehicle body 110 allowing for attachment of hoses or the like for delivering firefighting fluid, such as water, gel, or foam, to the set of conduits from an environment outside of the vehicle 100. Along these lines, the set of hoses may further attach to fluid sources such as hydrants, tanks, trucks or trailers, combinations thereof, etc.

Additionally, the firefighting equipment 112 may include a monitor 142 at the front 132 of the firefighting vehicle body 110 (e.g., see FIGS. 1 and 5). The monitor 142 receives the firefighting fluid conducted through the set of conduits 140 and emits the firefighting fluid toward desired locations in the environment.

Furthermore, the firefighting equipment 112 may include other apparatus such as a frontend head attachment 144 disposed at the front 132 of the firefighting vehicle body 110. By way of example, the frontend head attachment 144 includes a plow for pushing, separating, spreading materials, etc. However, other apparatus are suitable for the frontend head attachment 144 (e.g., a forklift, a forklift/plow combination, and so on).

It should be understood that the firefighting vehicle body 110 and/or the firefighting equipment 112 may provide certain other features such as a deck section which serves as a platform for performing various operations such as supporting specialized sensing equipment, carrying a tank that holds foam concentrate (e.g., for mixing with water before spraying), supporting a fan, supporting an array of lights and/or other equipment, carrying cargo, combinations thereof, etc.

As best seen in FIGS. 4 and 5, the vehicle receiver 114 resides on the rear 130 of the firefighting vehicle body 110 to enable installation and support of the vehicle accessory 116. However, due to limited space and/or the possibility of interfering with various equipment, it may be difficult to place another vehicle receiver 114 on the rear 130 of the firefighting vehicle body 110.

Attachment of the vehicle accessory 116 involves inserting an insert (or tube) of the vehicle accessory 116 into the vehicle receiver 114 in the positive X-direction. Removal of the vehicle accessory 116 involves sliding the insert of the vehicle accessory 116 out of the vehicle receiver 114 in the negative X-direction.

In some embodiments, the vehicle receiver 114 is an elongated shaft which is sized, gauged, etc. to support a variety of vehicle accessories 116. Along these lines, the vehicle receiver 114 may be a pipe (or conduit) constructed and arranged to receive the insert of the vehicle accessory 116. In some arrangements, the vehicle receiver 114 has a square cross-section (e.g., 1.5”x1.5”, 2.0”x2.0”, 2.5”x2.5”, etc.) to receive the insert (e.g., an elongated solid member having a square cross-section).

Retaining the vehicle accessory 116 to the firefighting vehicle body 110 may involve installing a pin 150 through both the vehicle receiver 114 and the insert of the vehicle accessory 116 (e.g., an L-shaped bolt). While the pin 150 is in place, the insert of the vehicle accessory 116 and the vehicle receiver 114 are locked (or held) together. Additionally, the pin 150 is removed to unlock (or release) the vehicle accessory 116 from the vehicle receiver 114.

In some embodiments, the vehicle receiver 114 the pin 150 may be held in place by a cotter pin (e.g., which slides through a bore in the pin 150 at the end opposite to end which bends to form the L) to richly and reliably retain the vehicle accessory 116 (e.g., see FIG. 4). Nevertheless, the vehicle accessory 116 may be removed, reinstalled, replaced, etc. by simply removing the cotter pin and then removing the pin 150 from the vehicle receiver 114.

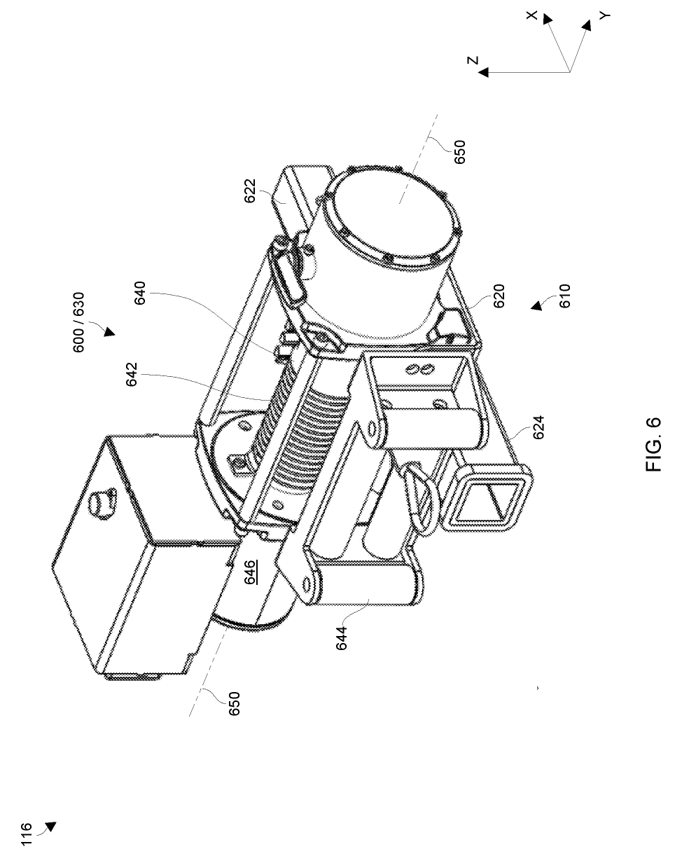

As will be explained in further detail shortly, the vehicle accessory 116 includes an auxiliary receiver 160 which enables an auxiliary accessory to further attach to the vehicle body 110 (e.g., see FIG. 4). In some arrangements, the auxiliary receiver 160 has the same geometry as that of the vehicle receiver 114 and is therefore capable of receiving and retaining an auxiliary accessory. Such a feature enables multiple accessories to attach to the vehicle body 110 without consuming additional space on the vehicle body 110. Further details will now be provided with reference to FIGS. 6 through 9.

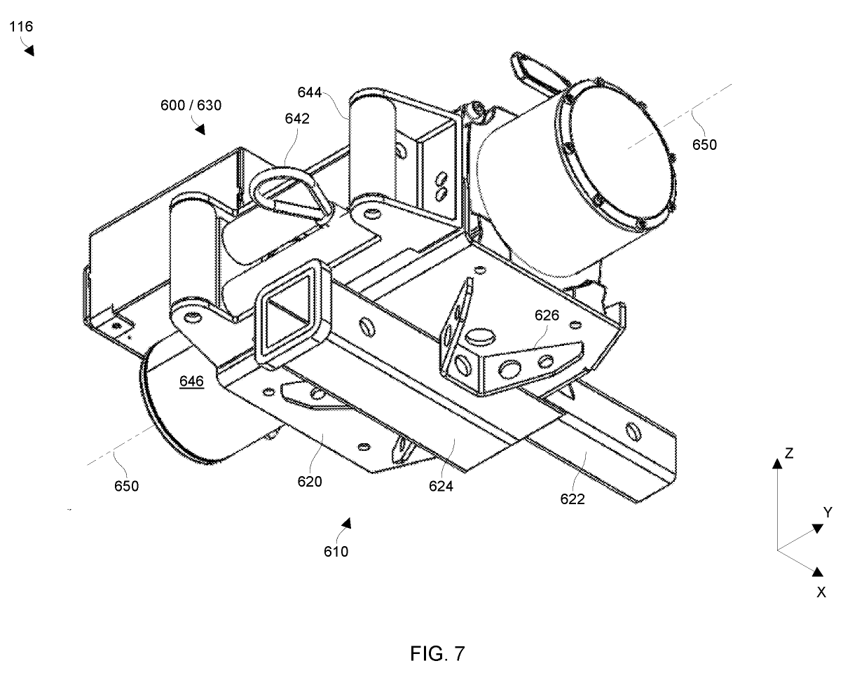

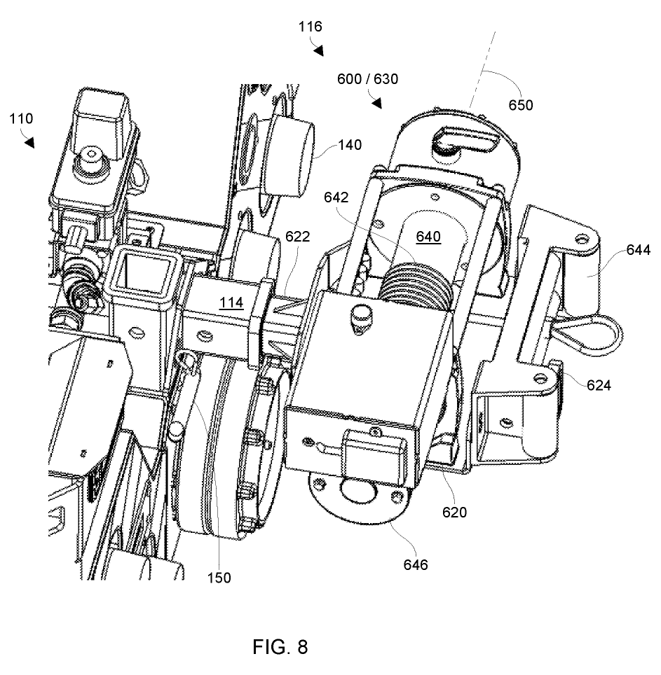

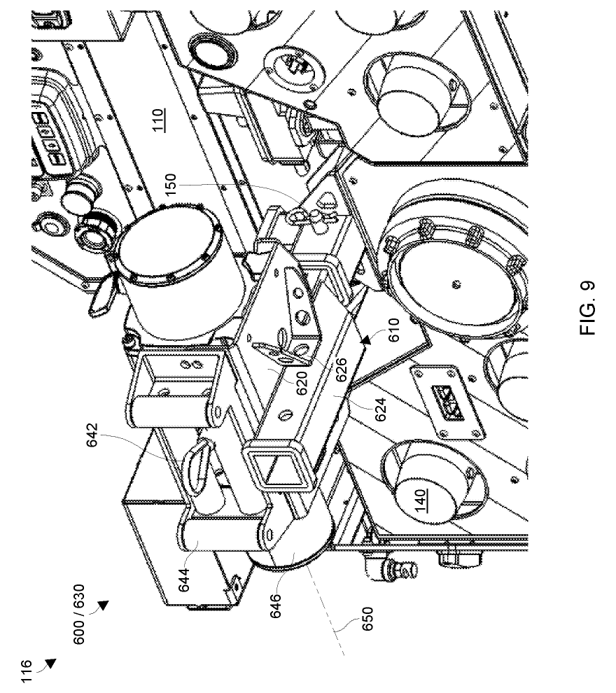

FIGS. 6 through 9 shows details of the example vehicle accessory 116 in accordance with certain embodiments. FIG. 6 is a perspective view of the example vehicle accessory 116. FIG. 7 is another perspective view of the example vehicle accessory 116. FIG. 8 is a perspective view showing partial engagement of the example vehicle accessory 116 with the vehicle receiver 114. FIG. 9 is another perspective view showing full engagement of the example vehicle accessory 116 with the vehicle receiver 114.

The example vehicle accessory 116 is a winch attachment which enables the firefighting robotic vehicle 100 to pull (or tow) objects from the rear 130 (also see FIGS. 1, 2 and 5). The vehicle accessory 116 includes equipment 600 and an attachment assembly 610.

The equipment 600 is constructed and arranged to operate while attached to firefighting vehicle body 110. Such equipment 600 enhances and/or augments operation of the firefighting robotic vehicle 100 (also see FIGS. 1 and 2). Along these lines, the firefighting robotic vehicle 100 is then able to pull or tow objects from the rear 130 (FIGS. 1 and 2).

The attachment assembly 610 is constructed and arranged to attach the equipment 600 to the firefighting vehicle body 110. As will be explained in further detail shortly, the attachment assembly 610 is further constructed and arranged to enable an auxiliary accessory to attach to the firefighting robotic vehicle 100. However, the auxiliary accessory attaches to the vehicle 100 indirectly through the vehicle accessory 116 thus alleviating the need to consume more space on the rear 130 of the vehicle 100.

As shown in FIGS. 6 and 7, the attachment assembly 610 includes a base 620, an insert (or tube) 622, an auxiliary receiver 624, and a set of gussets 626. The base 620 is constructed and arranged to support the equipment 600. The insert 622 couples with the base 620 and is constructed and arranged to engage with the vehicle receiver 114 (also see FIG. 4). The auxiliary receiver 624 couples with the base 620 and is constructed and arranged to engage with an insert of an auxiliary accessory that is different from the vehicle accessory 116. The set of gussets 626 provides strength to the attachment assembly 610.

In this example, the equipment 600 includes a winch device 630 which, when attached to the firefighting robotic vehicle 100, enables the vehicle 100 to pull, tow, etc. loads relative to the firefighting vehicle body 110. Along these lines, the winch device 630 attaches to a location adjacent the set of hose couplings 140 and is able to operate from that location (FIGS. 1 and 2). In such arrangements, operation of the equipment 600 avoids interference with any hoses that connect to lower and/or lateral hose couplings 140.

The winch device 630 includes a spool 640, a cable 642, a cable guide 644, and a motor 646. The spool 640 has an axis of rotation 650 which extends along the Y-axis and which is parallel to the rear 130 of the vehicle body 110 (i.e., the Y-Z plane) and perpendicular to axis defined by the insert 622 and the vehicle receiver 624 for installation/removal (i.e., the X-axis). The cable 642 winds at least partly around the spool 640. Additionally, the cable guide 644 defines an opening through which the cable 642 passes. Furthermore, the motor 644 is supported by the base 620 of the attachment assembly 610 and is constructed and arranged to turn the spool 640 to control winding/unwinding of the cable 642 relative to the spool 640 through the cable guide 644. Accordingly, the winch device 630 is able to draw and/or tow objects behind the vehicle body 110.

In some arrangements, the cable guide 644 is disposed above the auxiliary receiver 624 of the attachment assembly 610. Accordingly, the cable 642 extends from the vehicle 100 from a location that is above the auxiliary accessory attachment point to avoid interference.

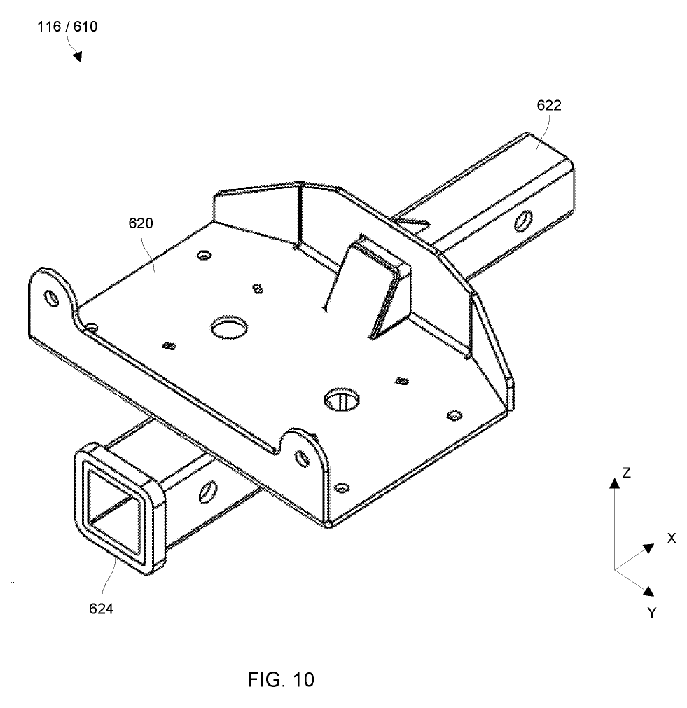

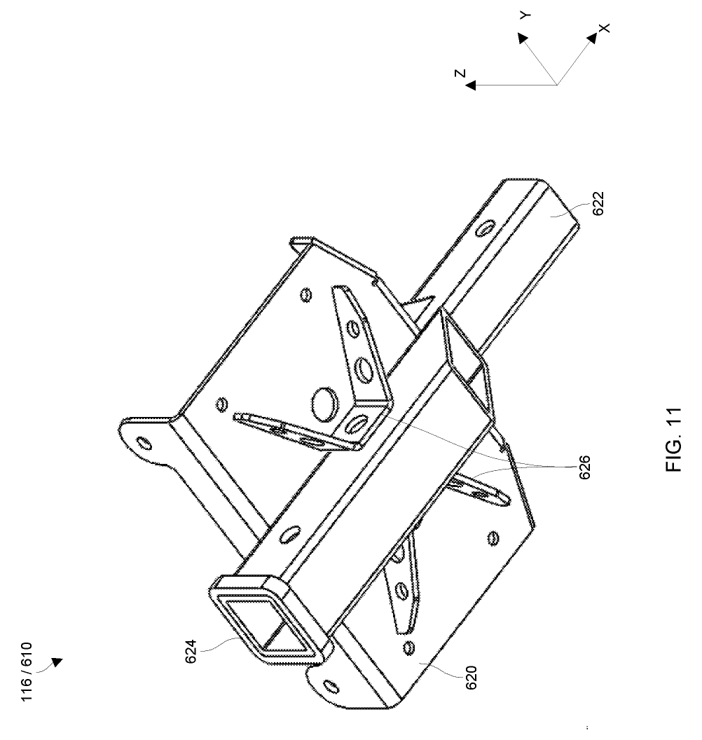

It should be appreciated that it may make sense to attach another accessory to the vehicle 100 while the vehicle 100 is operating in the field. However, rather than detach the vehicle accessory 116 (e.g., by removing the pin 150 to unlock the insert 622 from the vehicle receiver 114), the other accessory may be attached to the vehicle 100 by simply utilizing the auxiliary receiver 624 of the vehicle accessory 116. Accordingly, the vehicle 100 does not lose the abilities provided by the vehicle accessory 116, and extra time and effort is not wasted in removing the vehicle accessory 116. Further details will now be provided with reference to FIGS. 10 and 11.

FIGS. 10 and 11 show certain details of the attachment assembly 610 of the vehicle accessory 116. FIG. 10 is a perspective view of the attachment assembly 610 from an elevated angle. FIG. 11 is a perspective view of the attachment assembly 610 from a lower angle. As mentioned earlier in connection with FIGS. 6 through 9, the attachment assembly includes a base 620, an insert 622, an auxiliary receiver 624, and a set of gussets 626.

The base 620 includes a plate which extends in the X-Y plane to serve as a horizontal platform that supports the equipment 600 off the rear 130 of the vehicle body 110 (FIGS. 6 through 9). In some arrangements, the base 620 further includes or defines various features such as mounting holes to enable hardware to fasten the equipment 600 to the base 620, flanges which may extend in a direction that is perpendicular to the X-Y plane to properly support and/or position the equipment on the base 620, welds/ribs/bends for added strength, and so on.

It should be understood that the particular form factor of the base 620 may be specific to the particular equipment 600 that is supported by the base 620. Along these lines, the plate of the base 620 is generally rectangular to accommodate the rectangular footprint of the winch device 630 (FIGS. 6 and 7). For other types of equipment 600, the base 620 may have other shapes (e.g., elongated, arc-shaped, irregular, narrow, upright, combinations thereof, etc.).

The insert 622 couples with base 620 and extends along the X-axis for insertion into the vehicle receiver 114 (FIGS. 4 and 5). Lateral holes through the insert 622 enable locking of the insert 622 with the vehicle receiver 114 (e.g., via a pin 150).

In some arrangements, at least a portion of the insert 622 is welded to the base 620 for added attachment strength. In some arrangements, at least part of the insert 622 is integrated with the base 620 (e.g., a portion of the base 620 is bent upward to form a back end of the insert 622). In some arrangements, a flanged portion of the base 620 which extends in the Y-Z plane retains an end portion of the insert 622 with the base 620 for additional attachment strength (FIG. 10). Other features (additional flanges, welds, ribs, etc.) may exist to further strengthen attachment of the insert 622 with the base 620.

The auxiliary receiver 624 couples with base 620 and extends along the X-axis to enable attachment of an auxiliary accessory to the vehicle accessory 116. Lateral holes through the auxiliary receiver 624 enable locking of the auxiliary receiver 624 with an insert of the auxiliary receiver (e.g., via a pin).

With the insert 622 and the auxiliary receiver 624 being parallel with each other along the X-axis (e.g., with the insert 622 being mounted to a top side of the base plate and the auxiliary receiver 624 being mounted to a bottom side of the base plate), the auxiliary receiver 624 is able to attach in the same orientation to the vehicle body 110 when attached to the vehicle accessory 116 as the auxiliary receiver 624 would be if directly attached to the vehicle receiver 114. In some arrangements, the auxiliary receiver 624 is mounted underneath the base 620 to enable positioning of an attached auxiliary accessory at substantially the same height and/or location as the vehicle accessory 116 relative to the vehicle body 110. In some arrangements, an end of the insert 622 overlaps with an end of the auxiliary receiver 624 to maximize insert and receiver lengths for strength purposes.

The set of gussets 626 (e.g., see FIG. 11) provides strength to the base 620 to support the equipment 600 as well as to strengthen attachment of the auxiliary receiver 624 to the base 620. Along these lines, the set of gussets 626 provides strength to support loading perpendicular to the base plate and axial loading from the auxiliary receiver 624.

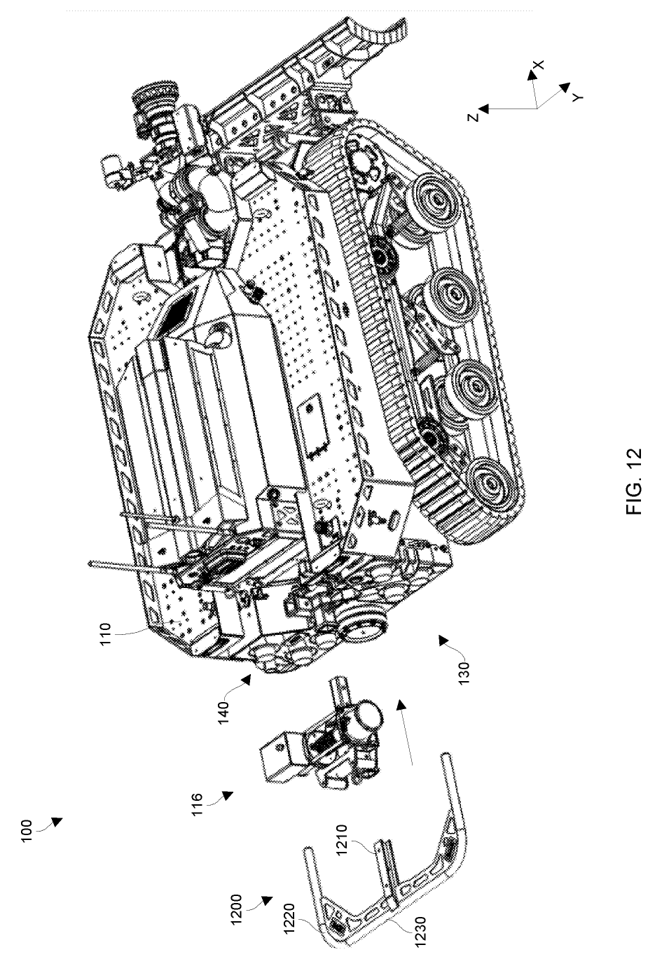

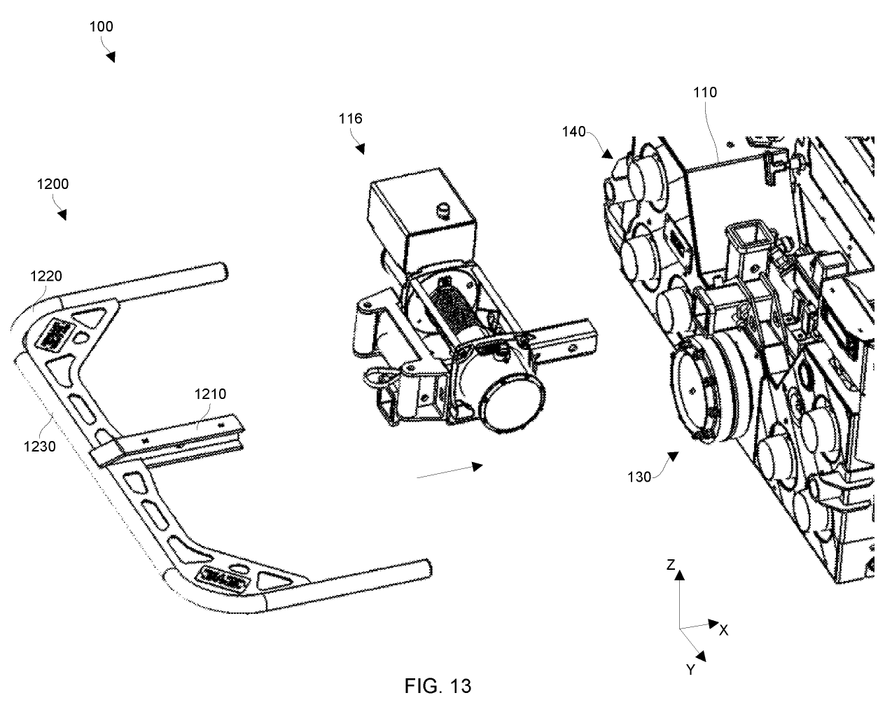

In some arrangements, the set of gussets 626 includes a left V-shaped gusset 626 welded to the bottom side of the base plate and to a left side of the auxiliary receiver 624, and a right V-shaped gusset 626 welded to the bottom side of the base plate and to a right side of the auxiliary receiver 626. In some arrangements, the set of gussets 626 define holes for strength, weight control, etc. Further details will now be provided with reference to FIGS. 12 and 13.

FIGS. 12 and 13 show how the firefighting robotic vehicle 100 utilizes multiple accessories 116, 1200. FIG. 12 is a system view. FIG. 13 is a detailed view.

As shown in FIGS. 12 and 13, the multiple accessories 116, 1200 may be attached to the rear 130 of the vehicle body 110 in a manner that consumes little to no extra space. That is, the vehicle accessory 116 attaches directly to the vehicle body 110 via the vehicle receiver 114 (also see FIGS. 1 and 2). Additionally, the auxiliary accessory 1200 attaches indirectly to the vehicle body 110 via the vehicle accessory 116.

By way of example, the auxiliary accessory 1200 is a hose manager which manages hoses which may connect to the rear 130 of the vehicle 100. Such a hose manager includes an auxiliary insert 1210 and an elongated section 1220 (e.g., a lateral structure). The auxiliary insert 1210 of the hose manager is constructed and arranged to engage a receiver such as either the auxiliary receiver 626 of the vehicle accessory 116 or the vehicle receiver 114 on the rear 130 of the vehicle body 110 when the vehicle receiver 114 is not present.

The elongated section 1220 couples with the hose manager insert 1210. In some arrangements, the elongated section 1220 includes braces, scaffolding, flanges, tabs, welds, combinations thereof, etc. for additional support/strength. The elongated section 1220 defines a hose deflection surface 1230 to manage a set of hoses when the set of hoses couples with the set of hose couplings 140.

It should be understood that other types of accessories are suitable for attaching to the vehicle accessory 116. Along these lines, any accessory that is able to attach to the vehicle receiver 114 on the rear 130 of the vehicle body 110 may alternatively attach to the auxiliary receiver 626 of the vehicle accessory 116. As a result, multiple accessories 116, 1200 may be attached in a manner that consumes little to no extra space on the rear 130 of the vehicle body 110. Moreover, the auxiliary accessory 1200 may be provisioned with an auxiliary receiver in a similar manner.

As described above, improved techniques are directed to attaching, to a vehicle receiver 116 of the firefighting vehicle 100, a vehicle accessory 116 which has an auxiliary receiver 626. With the auxiliary receiver 626, yet another accessory 1200 may be attached to the firefighting vehicle 100. In some arrangements, the vehicle accessory 116 is a winch attachment onto which an auxiliary accessory 1200 attaches (e.g., a hose manager, a platform or shelf, an electronic device, combinations thereof, etc.). Accordingly, multiple accessories 116, 1200 may be attached to a firefighting robotic vehicle 100 in a manner that consumes little to no extra space.

It should be appreciated that, in the general field of receiver hitch implements and specifically with regard to firefighting robots, there is a need to attach accessories in a manner that minimizes consumed space.

Along these lines, a typical winch mount uses the vehicles standard receiver when installed meaning the user will have to remove it if the user wishes to use any other attachment that uses the same receiver. Unfortunately, this is because conventional winch mounts serve one purpose and that is to hold the winch.

However, suppose that the user needs to use a ball hitch (or whatever type of implement desired) instead of the winch mount. Conventionally, the best way to accomplish something like this would have been to remove the winch mount from the hitch receiver on the vehicle and then install a ball hitch. In this situation, since the winch mount uses the receiver tube, you would have to uninstall the winch mount from the vehicle and store it somewhere to be able to use the receiver for any other purpose.

In accordance with certain embodiments, there is no need to remove a winch accessory. Rather, the winch accessory is itself provisioned with a hitch receiver. Accordingly, the user can instead use the receiver that is on the winch accessory. This allows the user to have a winch installed and have an open receiver at the same time.

In some embodiments, a 2-inch receiver tube is welded it to the bottom of a winch mount. Such a winch mount may have a tube that goes into the 2-inch standard receiver of any vehicle and then has a plate welded to the tube. That plate is where both the winch device itself is mounted. The 2-inch receiver tube is then welded underneath the plate so that the winch mount provides an available 2-inch receiver.

In accordance with certain embodiments disclosed herein, a user is able to leave the winch installed and have an open receiver that can be used. Such ability is unavailable with conventional winch mounts which use the vehicle's standard receiver (i.e., the user must remove the conventional winch mount to use another attachment that uses the same receiver).

As disclosed herein, a user can install a winch and have an open receiver at the same time. Such improvements can be used on any vehicle that uses a winch mount so that the user can have the winch installed and still have the ability to attach another accessory.

Such improvements are suitable for use in almost any industry that has a vehicle with a receiver hitch and also utilizes a winch. This can range from not only firefighting and emergency vehicles but also off road, rescue/recovery, towing, industrial, agricultural vehicles to name a few. Really any vehicle that has a hitch and needs to utilize a winch. Moreover, the features can easily be modified for any size winch and receiver hitch (smaller, larger, upgrade in receiver size where the receiver diameters are different sizes, downgrade in receiver size where the receiver diameters are different sizes, etc.).

As described above, a vehicle accessory assembly having multiple vehicle accessories, which fasten together via a receiver/insert connection, may attach to a firefighting vehicle 100. Along these lines, a first vehicle accessory 116 such as a winch device 630 may attach directly to a rear (or back) 130 of the firefighting vehicle 100, and a second vehicle accessory 1200 such as a hose manager may fasten to the first vehicle accessory via the receiver/insert connection (e.g. see FIGS. 12 and 13). Such a feature advantageously provides convenient multi-accessory access to the rear 130 of the firefighting vehicle 100 while the second vehicle accessory 1200 consumes little to no extra space on the firefighting vehicle body 110.

At this point, it should be further understood that a vehicle accessory assembly may attach to a location other than the back of the firefighting vehicle 100 such as to a front of the firefighting vehicle 100 in a manner similar to that described above. Along these lines and in accordance with certain embodiments, a vehicle accessory assembly which has multiple vehicle accessories attaches to a front of the firefighting vehicle 100. Such a feature advantageously provides convenient multi-accessory access at the front of the firefighting vehicle 100. For example, a plowing device may attach directly to the firefighting vehicle 100 via a first interface, and a winch attachment may attach to the plowing device via a second interface, thus enabling the plowing device to anchor the firefighting vehicle 100 while the winch attachment operates.

In some arrangements, after a first vehicle accessory attaches to the front of the firefighting vehicle body 110, a second vehicle accessory attaches to the first vehicle accessory and consumes little to no extra space on the firefighting vehicle body 110. In some arrangements, the firefighting vehicle 100 has vehicle accessory assemblies having multiple vehicle accessories at both the front and back.

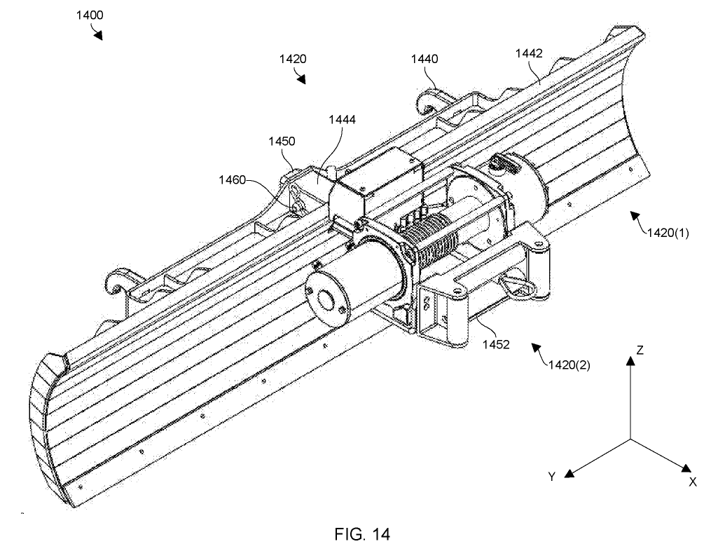

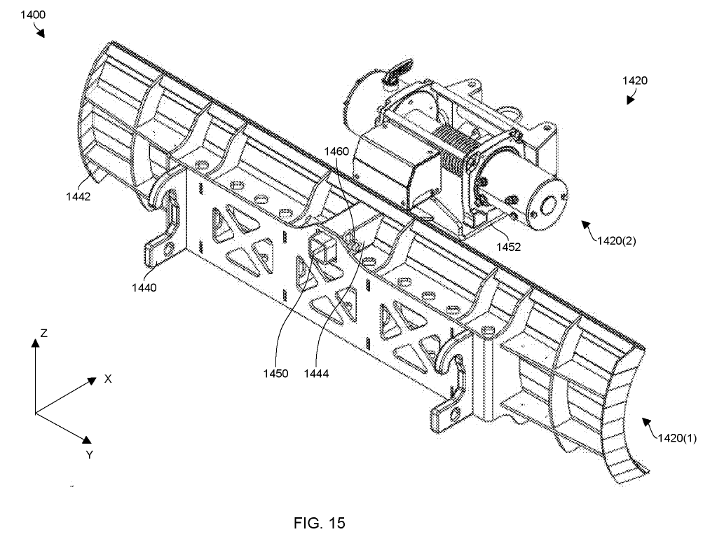

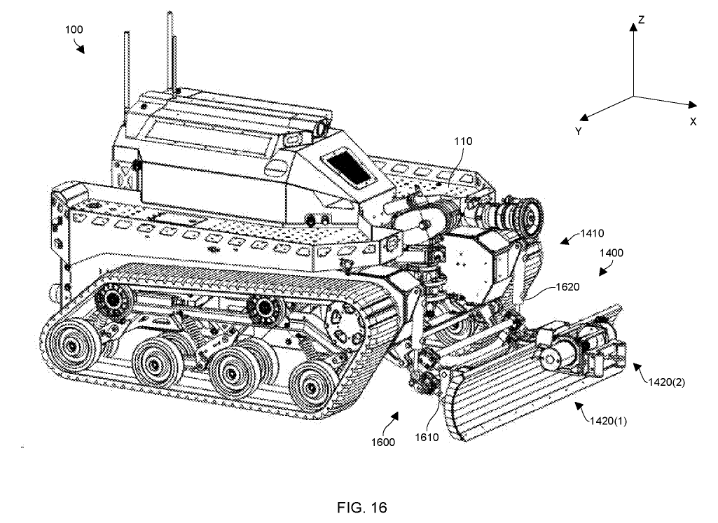

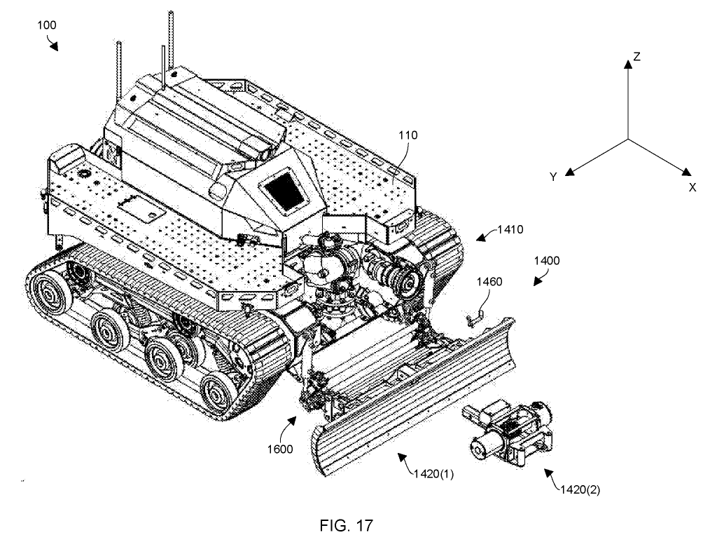

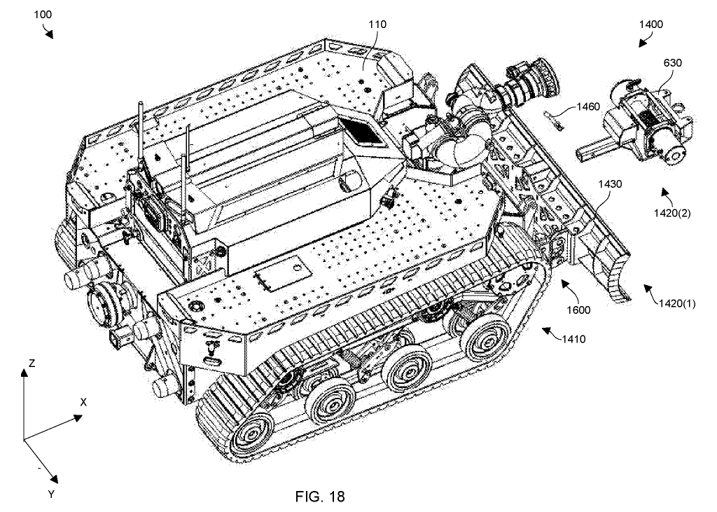

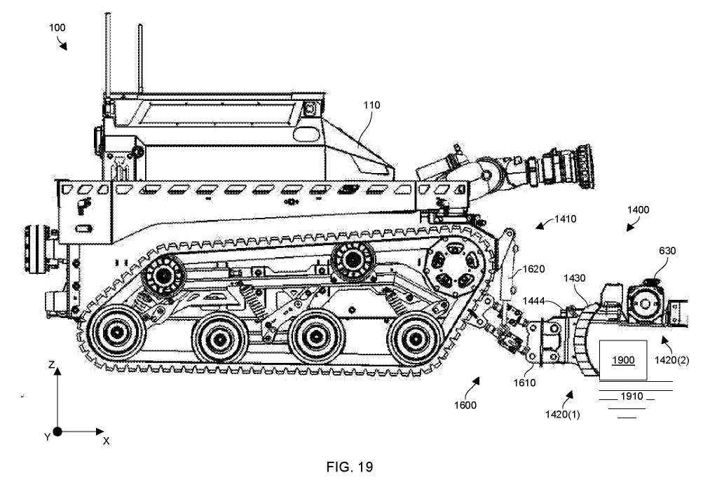

FIGS. 14 through 19 show details of a vehicle accessory assembly 1400 in accordance with certain embodiments. FIG. 14 shows the vehicle accessory assembly 1400 from a first angle. FIG. 15 shows the vehicle accessory assembly 1400 from a second angle. FIG. 16 shows the firefighting robotic vehicle 100 having the vehicle accessory assembly 1400. FIG. 17 shows a partially exploded view of the firefighting robotic vehicle 100 having the vehicle accessory assembly 1400. FIG. 18 shows another partially exploded view of the firefighting robotic vehicle 100 having the vehicle accessory assembly 1400. FIG. 19 shows a side view of the firefighting robotic vehicle 100 having the vehicle accessory assembly 1400.

As shown in FIGS. 14 through 19, the vehicle accessory assembly 1400 is constructed and arranged to attach to a front 1410 of the firefighting vehicle 100 (e.g., see FIGS. 17 through 19). Along these lines, it should be appreciated that there may be situations in which it is desirable for the firefighting vehicle 100 to enjoy multi-accessory operability and/or connectivity at the front of the firefighting vehicle 100.

The vehicle accessory assembly 1400 includes 1420 multiple vehicle accessories 1420(1), 1420(2) (collectively, vehicle accessories 1420). The vehicle accessory 1420(1) is constructed and arranged to attach directly to the firefighting vehicle body 110, while the vehicle accessory 1420(2) is constructed and arranged to attach indirectly to the firefighting vehicle body 110 through the vehicle accessory 1420(1). Accordingly, the vehicle accessory 1420(1) consumes little to no extra space on the firefighting vehicle body 110.

By way of example, the vehicle accessory 1420(1) is a plow attachment (or device) 1430 and the vehicle accessory 1420(2) is a winch device 630. In some arrangements, the firefighting vehicle 100 includes multiple winch devices 630, one for use at the front 1410 of the firefighting vehicle 100 and another for use at the rear (or back) 130 of the firefighting vehicle 100 (also see FIG. 12). In other arrangements, the firefighting vehicle 100 includes a single winch device 630 that is installable at either the front 1410 or the rear 130 of the firefighting vehicle 100. It should be understood that vehicle accessories 1420 are shown as a plow attachment 1430 and a winch device 630 for illustration purposes and may take the form of other types of vehicle accessories as well, e.g., a forklift, a bumper, a blast shield, and so on.

Moreover, it is possible to add yet another vehicle accessory 1420 to the vehicle accessory assembly 1400. For example, the winch device 630 was described above as being equipped with an auxiliary receiver 624 enabling attachment of a third vehicle accessory 1420, and so on.

As best seen in FIGS. 14 and 15, the vehicle accessory 1420(1) includes a vehicle interface 1440, equipment 1442, and a receiver 1444. Additionally, the vehicle accessory 1420(2) includes an insert 1450 and equipment 1452.

With regard to the vehicle accessory 1420(1), the vehicle interface 1440 is constructed and arranged to attach the vehicle accessory 1420(1) to a vehicle. It should be appreciated that the vehicle may be the earlier-mentioned tracked firefighting vehicle 100 (also see FIGS. 16 through 19). Alternatively, the vehicle could have other form factors such as a utility vehicle or other non-tracked vehicle such as a tractor or a dump truck, and so on.

Furthermore, the C-hanger type of vehicle interface 1440 in which the weight and cantilevering effect provided by the vehicle accessory 1420(1) maintains attachment of the vehicle accessory 1420(1) to the vehicle is shown by way of example only. Other engagement/coupling arrangements are suitable for use as the vehicle interface 1440 as well. For example, in some arrangements, there is a secondary mode of retention which involves placing a pin through a lower hole opposite (or near the bottom of) the "C" which may engage one or more structures of the vehicle interface 1440.

The equipment 1442 of the vehicle accessory 1420(1) couples with the vehicle interface 1440 and is constructed and arranged to operate while the vehicle accessory 1420(1) is attached to the vehicle. Along these lines, in the context of the plow attachment (or device) 1430, the equipment 1442 takes the form of a plow blade (or moldboard) which is able to push material, collect material, spread material, etc.

The receiver 1444 of the vehicle accessory 1420(1) couples with at least one of the equipment 1442 and the vehicle interface 1440 and is constructed and arranged to support attachment of the vehicle accessory 1420(2). Along these lines, the receiver 1444 may have a similar form factor as the earlier-mentioned vehicle receiver 114 (e.g., also see FIGS. 4 and 5) and/or the earlier-mentioned auxiliary receiver 624 (e.g., also see FIGS. 6 and 7). For example, the receiver 1444 may be in the shape of an elongated tube with a square cross-section although other configurations are suitable for use as well.

In some arrangements, the receiver 1444 is welded to various contact areas of the equipment 1442 and/or the vehicle interface 1440. In some arrangements, the receiver 1444 is secured via hardware and/or supported by brackets, gussets, straps, etc. (perhaps with welds) to robustly and reliably fasten the receiver 1444 in place.

With regard to the vehicle accessory 1420(2), the insert 1450 is constructed and arranged to engage with the receiver 1444 of the vehicle accessory 1420(1). Along these lines, the insert 1450 may have a similar form factor as the earlier-mentioned insert 622 (e.g., also see FIGS. 6 and 7) and/or the earlier-mentioned insert 1210 (e.g., also see FIG. 12).

The equipment 1452 of the vehicle accessory 1420(2) is constructed and arranged to operate while the insert 1450 engages with the receiver 1444 of the vehicle accessory 1420(1) to hold the vehicle accessory 1420(2) in place. Along these lines, in the context of the winch device 630, the equipment 1452 is able to perform pulling, towing, winding, etc.

In some embodiments, the vehicle accessory assembly 1400 further includes a pin (or crossbar) 1460 which locks the vehicle accessors 1420 together. Along these lines, the pin 1460 is constructed and arranged to pass through holes defined in the receiver 1444 of the vehicle accessory 1420(1) and the insert 1452 of the vehicle accessory 1420(2) while the holes are aligned. Accordingly, the insert 1452 is then prevented from escaping from the receiver 1444 until the pin is removed 1460.

In some arrangements, the pin 1460 passes through the receiver 1444 and the insert 1452 horizontally. Also, in some arrangements, the pin 1460 is equipped with a retaining mechanism (e.g., a cotter pin) that slips through an end of the pin 1460 enabling the pin 1460 to be held in place (e.g., via a pin head on one end and the retaining mechanism on the other end). Other pin orientations/configurations and/or retaining mechanisms are suitable for use as well.

In some arrangements, the receiver 1444 is flush with the equipment 1442 of the vehicle accessory 1420(1). Along these lines, in the context of the plow attachment 1430 (e.g., see FIG. 17), the end of the receiver 1444 is flush with the plow blade to prevent the receiver 1444 from protruding from the plow blade in a manner that would interfere with operation (e.g., plowing).

In some arrangements, a back end of the receiver 1444 is open (or unblocked). Accordingly, any debris that enters the receiver 1444 may be pushed through either end to clear the receiver 1444 so that the receiver 1444 can receive the insert 1452 of the vehicle accessory 1420(2).

As best seen in FIGS. 16 through 19, the firefighting vehicle 100 further includes an accessory interface 1600 coupled with the firefighting vehicle body 110. The accessory interface 1600 is constructed and arranged to interface with accessory equipment such as the vehicle accessory assembly 1400. Along these lines, the accessory interface 1600 may include attachment features 1610 (e.g., see FIGS. 16 and 19) enabling attachment of the vehicle accessory 1420(1) of the vehicle accessory assembly 1400 (also see the vehicle interface 1440 in FIGS. 14 and 15). The accessory interface 1600 may include other features 1620 (e.g., FIGS. 16 and 19) as well such as actuators which raise, lower, guide or otherwise maneuver and/or facilitate operation of the vehicle accessory 1420(1).

It should be appreciated that the vehicle accessory assembly 1400 enables the firefighting vehicle 100 to enjoy certain advantages. For example, suppose that the firefighting vehicle 100 has been using the plow attachment 1430 to plow materials in front of the firefighting vehicle 100 (e.g., to push recently extinguished debris). At this point, it may be desirable to use the winch device 630 to pull (or tow) some of the materials. In this situation, it may be inconvenient or difficult to reorient the firefighting vehicle 100 such that the back of the firefighting vehicle 100 faces the plowed materials.

However, in accordance with certain embodiments, the winch device 630 is simply attached to the plow attachment 1430 (e.g., see FIG. 16). In some arrangements, the winch device 630 is further electrically connected with componentry of the firefighting vehicle 100 to enable winch operation (e.g., access to electric power from the firefighting vehicle 100). At this point, the winch device 630 is able to pull loads and/or perform other winch operations.

Advantageously, the vehicle accessory assembly 1400 may be employed to enable the winch device 630 to pull loads without imposing stress on the firefighting vehicle 100. Along these lines, the plow attachment 1430 may be positioned behind a fixed object 1900 or somewhat embedded into the terrain of the vehicle environment 1910 (e.g., see FIG. 19). Such positioning may anchor the firefighting vehicle 100 in place during winch device operation. Along these lines, the winch device 630 is then able to pull loads in the negative X-direction while counter force pulls the plow attachment 1430 in the opposite positive X-direction. As this happens, there are no stresses placed on the firefighting vehicle 100 which would cause issues (e.g., stresses on the suspension, undesirable crawl of the vehicle in the positive X-direction due to the load overcoming tractive forces, etc.). Rather, the full power of the winch device 630 is now available for use in pulling the load.

Nevertheless, it should be understood that the vehicle accessories 1420 are able to operate regardless of whether the accessory interface 1600 is in the raised or lowered positions. Moreover, the vehicle accessories 1420 may operate while the accessory interface 1600 is transitioning between the raised and lowered positions for enhanced flexibility and/or utility.

In some arrangements, the receiver 1444 is positioned adjacent an upper half (or top section) of the vehicle accessory 1420(1) (e.g., a plow blade) to provide height to the winch device 630 along the Z-axis so that the winch device 630 clears the fixed object 1900 in the environment 1910 (e.g., a curb, a tree stump, etc.). This relatively high location for the receiver 1444 also reduces the likelihood of catching debris within the receiver 1444 when the vehicle accessory 1420(1) is in full use.

In some arrangements, the front plowing surface defined by the plow blade has a face height and a face width. The plow blade defines a hole (or opening) front plowing surface which is centrally positioned relative to the face height and the face width (e.g., one to six inches above the mid-line so that the hole is through the upper half of the plow blade). Such a feature enables the receiver 1444 to reside at a position that is well suited for supporting the winch device 630.

As explained above, a vehicle accessory assembly 1400 may attach to a front 1410 of the firefighting vehicle 100. Along these lines and in accordance with certain embodiments, the vehicle accessory assembly 1400 has multiple vehicle accessories 1420 attaches to the front 1410 of the firefighting vehicle 100 via a receiver/insert connection. Such a feature advantageously provides convenient multi-accessory access at the front of the firefighting vehicle 100. Such vehicle accessory assemblies, as described herein and in accordance with certain embodiments, may have any number of vehicle accessories 1420 (e.g., one, two, three, four, etc.) and/or may attach to any location on a vehicle (e.g., the front, the rear, etc.).

In accordance with certain embodiments, a plow-mounted receiver hitch provides an alternate location for mounting vehicle attachments (e.g. cable winch). A plow is most commonly installed on the front of a vehicle, whereas a traditional hitch receiver is most commonly located at the rear of the vehicle. In certain circumstances, the vehicle may not be able to maneuver or reposition to allow the use of the desired attachment when it is mounted on the rear of the vehicle. Providing an alternate attachment point increases the usability of the attachment in a wider variety of situations. In some cases, the plow may have a preexisting lift mechanism that allows for further flexibility in the positioning of the attachment. In some cases, the hitch receiver being integrated into a plow blade may increase the capacity of the attachment. In the case of a winch, the lower edge of the plow blade may be hooked on a fixed object (e.g. curb), which may provide substantially more resistance to the pull force than is possible with the tractive force of the vehicle alone. In this situation, the stresses incurred by the winching operation are transferred solely through the plow and into the fixed object, rather than through the vehicle’s structure.

In some embodiments, the plow-mounted hitch receiver incorporates a square tube into the structure of the plow. The receiver is oriented such that the opening faces forward and backward. The front of the receiver is flush with the face of the plow blade. The receiver is sized such that a hitch can be freely inserted into it, but is tight enough to the top, bottom, and sides of the hitch to minimize vertical and horizontal movement. A hole is drilled (e.g., horizontally or vertically) through the receiver to allow a pin to pass through the receiver and a similar hole in the hitch to lock the hitch in the receiver and prevent forward and backward movement of the hitch and attachment.

In some arrangements, there is only a horizontal pin. In other arrangements, there are horizontal and/or vertical orientation of the pin holes allows for easy pin access (e.g., at the top of the plow) for installing and removing the attachments.

In some arrangements, the rear of this receiver tube is open to enable any debris within the tube to be pushed all the way through (e.g., in case there is something stuck in the tube from plowing. In other arrangements, at the rear of the tube is a back plate, which acts as a stop for the hitch when the hitch is inserted into the receiver the correct distance for the holes in the receiver and hitch to align.

Without access to certain embodiments disclosed herein, it could have been necessary to reposition or elevate the vehicle. In certain situations, there may be insufficient space to maneuver or reposition the vehicle, or the vehicle may be disabled and incapable of repositioning itself. In the case of a winch, pulleys could also be used to route the cable where it is needed, although this requires additional equipment and setup time and effort. Tractive force of the vehicle may be increased by adding weight to the vehicle, but this has other drawbacks, including an increase in the amount of force (torque) and energy (fuel) required to move the vehicle. Tethering the vehicle to a fixed object may also increase the pull force possible; however, this method may subject a large portion of the vehicle’s structure to extreme stresses.

Advantages provided by certain embodiments overcome limited mounting positions for winch and other hitch-mounted attachments. Also such embodiments enable overcoming winch pull force limited by vehicle tractive force.

In some embodiments, the hitch receiver is flush-mounted to prevent interference with plow operation, is able to be lifted and lowered with plow blade, and includes a clevis pin hole for easy access.

Certain embodiments alleviate the need to reposition vehicle which may not be possible if vehicle is disabled. Certain embodiments alleviate the need to add weights to vehicle to increase tractive force (friction). Certain embodiments alleviate the need to tether vehicle to another object (building, tree, etc.) which could then subject full vehicle to pulling forces.

Although vehicle accessory assemblies were described above as attaching to the back and to the front of a vehicle, other vehicle locations are suitable as well. For example, either or both sides of the vehicle are suitable attachment locations for certain applications.

One embodiment is directed to a vehicle accessory assembly which has a first vehicle accessory including a vehicle interface constructed and arranged to attach to a vehicle, first equipment coupled with the vehicle interface, the first equipment being constructed and arranged to operate while the first vehicle accessory is attached to the vehicle, and a receiver coupled with at least one of the equipment and the vehicle interface, the receiver being constructed and arranged to support attachment of another vehicle accessory. The second vehicle accessory includes an insert constructed and arranged to engage with the receiver of the first vehicle accessory, and second equipment coupled with the vehicle interface, the second equipment being constructed and arranged to operate while the insert of the second vehicle accessory engages with the receiver of the first vehicle accessory.

Another embodiment is directed to a firefighting vehicle which includes a firefighting vehicle body constructed and arranged to perform firefighting operations, an accessory interface coupled with the firefighting vehicle body, the accessory interface, being constructed and arranged to interface with accessory equipment, and a vehicle accessory assembly constructed and arranged to attach to the accessory interface. The vehicle accessory assembly has a first vehicle accessory including:
A) a vehicle interface constructed and arranged to attach to a vehicle,
B) first equipment coupled with the vehicle interface, the first equipment being constructed and arranged to operate while the first vehicle accessory is attached to the vehicle, and
C) a receiver coupled with at least one of the equipment and the vehicle interface, the receiver being constructed and arranged to support attachment of another vehicle accessory.

The second vehicle accessory includes an insert constructed and arranged to engage with the receiver of the first vehicle accessory, and second equipment coupled with the vehicle interface. The second equipment is constructed and arranged to operate while the insert of the second vehicle accessory engages with the receiver of the first vehicle accessory.

In some arrangements, one of the first vehicle accessory and the second vehicle accessory is a winch attachment constructed and arranged to tow loads.

In some arrangements, the firefighting vehicle body defines a vehicle front constructed and arranged to face a burning target and a vehicle back constructed and arranged to face away from the burning target. Additionally, the accessory interface is disposed adjacent the vehicle front end.

In some arrangements, the first vehicle accessory is a plowing device and the second vehicle accessory is the winch attachment.

In some arrangements, the plowing device includes:
i) as the vehicle interface, a plowing device hanger constructed and arranged to connect the plowing device to the accessory interface of the firefighting vehicle; and
ii) as the first equipment, a plow blade constructed and arranged to plow material.

In some arrangements, the plow blade defines a front plowing surface to contact the material. Additionally, the receiver of the first vehicle accessory is disposed between the firefighting vehicle body and the front plowing surface.

In some arrangements, the receiver is accessible by the winch attachment through an opening in the front plowing surface.

In some arrangements, wherein the accessory interface of the firefighting vehicle is constructed and arranged to selectively raise and lower the plowing device relative to the firefighting vehicle body.

In some arrangements, the winch attachment is constructed and arranged to tow loads while the accessory interface is in a lowered configuration during a first operating time.

In some arrangements, the winch attachment is further constructed and arranged to tow loads while the accessory interface is in a raised configuration during a second operating time, and while the accessory interface transitions between the raised configuration and lowered configurations during a third operating time.

In some arrangements, the firefighting vehicle body defines a vehicle front constructed and arranged to face a burning target and a vehicle back constructed and arranged to face away from the burning target. Additionally, the accessory interface is disposed adjacent the vehicle front end. Furthermore, the first vehicle accessory is a plowing device which includes:
i) as the vehicle interface, a plowing device hanger constructed and arranged to connect the plowing device to the accessory interface of the firefighting vehicle, and
ii) as the first equipment, a plow blade constructed and arranged to plow material.

Also, the plow blade defines a front plowing surface to contact the material, and the receiver of the first vehicle accessory is disposed between the firefighting vehicle body and the front plowing surface.

In some arrangements, the receiver is accessible by the first vehicle accessory through an opening in the front plowing surface.

In some arrangements, the front plowing surface defined by the plow blade has a face height and a face width. Additionally, the opening is a hole in the plow blade which is centrally positioned relative to the face height and the face width.

In some arrangements, the accessory interface of the firefighting vehicle is constructed and arranged to selectively raise and lower the plowing device relative to the firefighting vehicle body.

In some arrangements, one of the first equipment and the second equipment is a winch device constructed and arranged to pull loads.

In some arrangements, the other of the first equipment and the second equipment is a plow device constructed and arranged to plow materials.

In some arrangements, the first vehicle accessory is a plowing device, and the first equipment includes a plow blade constructed and arranged to plow material.

In some arrangements, wherein the receiver of the first vehicle accessory is accessible through a hole in the plow blade to enable the second vehicle accessory to attach to the first vehicle accessory.

In some arrangements, the first vehicle accessory further includes a pin constructed and arranged to pass through a set of holes in the receiver to enable locking of the second vehicle accessory to the first vehicle accessory when the insert of the second vehicle accessory engages with the receiver and the pin is inserted through the set of holes.

Yet another embodiment is directed to a vehicle accessory which includes equipment constructed and arranged to operate while attached to a vehicle, and an attachment assembly constructed and arranged to attach the equipment to the vehicle. The attachment assembly has a base constructed and arranged to support the equipment. The attachment assembly further has an insert coupled with the base, the insert being constructed and arranged to engage with a vehicle receiver of the vehicle. The attachment assembly further has an auxiliary receiver coupled with the base, the auxiliary receiver being constructed and arranged to engage with an insert of an auxiliary accessory that is different from the vehicle accessory.

A further embodiment is directed to a firefighting vehicle which includes a firefighting vehicle body constructed and arranged to perform firefighting operations. The firefighting vehicle further includes a vehicle receiver coupled with the firefighting vehicle body. The firefighting vehicle further includes a vehicle accessory which includes (i) equipment constructed and arranged to operate while attached to firefighting vehicle body, and (ii) an attachment assembly constructed and arranged to attach the equipment to the firefighting vehicle body. The attachment assembly includes:
A) a base constructed and arranged to support the equipment,
B) an insert coupled with the base, the insert being constructed and arranged to engage with the vehicle receiver, and
C) an auxiliary receiver coupled with the base, the auxiliary receiver being constructed and arranged to engage with an insert of an auxiliary accessory that is different from the vehicle accessory.

In some arrangements, the equipment of the vehicle accessory includes a winch device coupled with the base of the attachment assembly, the winch device being constructed and arranged to pull loads relative to the firefighting vehicle body when the winch device is attached to the firefighting vehicle body via the attachment assembly.

In some arrangements, the winch device includes a spool, a cable wound at least partly around the spool, and a motor supported by the base of the attachment assembly. The motor is constructed and arranged to turn the spool to control winding of the cable around the spool.

In some arrangements, the base of the attachment assembly includes a plate constructed and arranged to provide a horizontal platform that supports the winch device when the insert of the attachment assembly is inserted into the vehicle receiver.

In some arrangements, the insert of the attachment assembly defines an insert axis along which the insert engages the vehicle receiver. Additionally, the auxiliary receiver defines an auxiliary receiver axis along which the auxiliary receiver receives the insert of the auxiliary accessory, the auxiliary receiver axis being parallel to the insert axis defined by the insert of the attachment assembly.

In some arrangements, the motor of the winch device has an axis of rotation that is perpendicular to the insert axis defined by the insert of the attachment assembly.

In some arrangements, the winch device further includes a cable guide that defines an opening through which the cable passes, the cable guide being disposed above the auxiliary receiver of the attachment assembly.

In some arrangements, the base of the attachment assembly includes a plate constructed and arranged to provide a horizontal platform to support the equipment. Additionally, at least a portion of the insert of the attachment assembly is disposed on a first side of the plate. Furthermore, at least a portion of the auxiliary receiver is disposed on a second side of the plate that is opposite the first side of the plate.

In some arrangements, at least a portion of the insert of the attachment assembly is disposed on a top side of the plate. Additionally, at least a portion of the auxiliary receiver is disposed on a bottom side of the plate.

In some arrangements, the attachment assembly further includes a set of gussets coupled with the plate and with the auxiliary receiver. The set of gussets provides strength to support loading perpendicular to the plate and axial loading from the auxiliary receiver.

In some arrangements, the set of gussets includes:
i) a left V-shaped gusset welded to the bottom side of the plate and to a left side of the auxiliary receiver, and
ii) a right V-shaped gusset welded to the bottom side of the plate and to a right side of the auxiliary receiver.

In some arrangements, a back side of the firefighting vehicle body includes a set of hose couplings constructed and arranged to couple with a set of hoses. Additionally, the vehicle receiver is disposed on the back side adjacent to the set of hose couplings.

In some arrangements, the equipment of the vehicle accessory includes a winch device coupled with the base of the attachment assembly. The winch device is constructed and arranged to pull loads from a location adjacent the set of hose couplings when the winch device is attached to the firefighting vehicle body via the attachment assembly.

In some arrangements, the auxiliary accessory is a hose manager which includes:
i) a hose manager insert constructed and arranged to engage with the auxiliary receiver, and
ii) an elongated section coupled with the hose manager insert, the elongated section defining a hose deflection surface to manage a set of hoses when the set of hoses couples with the set of hose couplings.

In some arrangements, the hose manager insert and the insert of the attachment assembly have a common form factor which enables the hose manager insert to engage with the vehicle receiver.

In some arrangements, the firefighting vehicle further includes:
i) a robotically controlled propulsion system coupled with the firefighting vehicle body, and
ii) a set of tracks driven by the robotically controlled propulsion system to form a firefighting robotic vehicle.

Other embodiments are directed to systems, sub-systems, apparatus, assemblies, componentry, and so on. Some embodiments are directed to various methods, devices, platforms, etc. which are involved in attaching vehicle accessories to a firefighting vehicle.

While various embodiments of the present disclosure have been particularly shown and described, it will be understood by those skilled in the art that various changes in form and details may be made therein without departing from the spirit and scope of the present disclosure as defined by the appended claims. Such modifications and enhancements are intended to belong to various embodiments of the disclosure.

What is claimed is:

1. A firefighting vehicle, comprising:
a firefighting vehicle body constructed and arranged to perform firefighting operations;
an accessory interface coupled with the firefighting vehicle body, the accessory interface, being constructed and arranged to interface with accessory equipment; and
a vehicle accessory assembly constructed and arranged to attach to the accessory interface, the vehicle accessory assembly having:
a first vehicle accessory including:
a vehicle interface constructed and arranged to attach to a vehicle,
first equipment coupled with the vehicle interface, the first equipment being constructed and arranged to operate while the first vehicle accessory is attached to the vehicle, and
a receiver coupled with at least one of the equipment and the vehicle interface, the receiver being constructed and arranged to support attachment of another vehicle accessory; and
a second vehicle accessory including:
an insert constructed and arranged to engage with the receiver of the first vehicle accessory, and
second equipment coupled with the vehicle interface, the second equipment being constructed and arranged to operate while the insert of the second vehicle accessory engages with the receiver of the first vehicle accessory.

2. The firefighting vehicle of claim 1, wherein one of the first vehicle accessory and the second vehicle accessory is a winch attachment constructed and arranged to tow loads.

3. The firefighting vehicle of claim 2, wherein the firefighting vehicle body defines a vehicle front constructed and arranged to face a burning target and a vehicle back constructed and arranged to face away from the burning target; and
wherein the accessory interface is disposed adjacent the vehicle front end.

4. The firefighting vehicle of claim 3, wherein the first vehicle accessory is a plowing device and the second vehicle accessory is the winch attachment.

5. The firefighting vehicle of claim 4, wherein the plowing device includes:
as the vehicle interface, a plowing device hanger constructed and arranged to connect the plowing device to the accessory interface of the firefighting vehicle; and
as the first equipment, a plow blade constructed and arranged to plow material.

6. The firefighting vehicle of claim 5, wherein the plow blade defines a front plowing surface to contact the material; and
wherein the receiver of the first vehicle accessory is disposed between the firefighting vehicle body and the front plowing surface.

7. The firefighting vehicle of claim 6, wherein the receiver is accessible by the winch attachment through an opening in the front plowing surface.

8. The firefighting vehicle of claim 4, wherein the accessory interface of the firefighting vehicle is constructed and arranged to selectively raise and lower the plowing device relative to the firefighting vehicle body.

9. The firefighting vehicle of claim 8, wherein the winch attachment is constructed and arranged to tow loads while the accessory interface is in a lowered configuration during a first operating time.

10. The firefighting vehicle of claim 9, wherein the winch attachment is further constructed and arranged to tow loads while the accessory interface is in a raised configuration during a second operating time, and while the accessory interface transitions between the raised configuration and lowered configurations during a third operating time.

11. The firefighting vehicle of claim 1, wherein the firefighting vehicle body defines a vehicle front constructed and arranged to face a burning target and a vehicle back constructed and arranged to face away from the burning target;
wherein the accessory interface is disposed adjacent the vehicle front end;
wherein the first vehicle accessory is a plowing device which includes:
as the vehicle interface, a plowing device hanger constructed and arranged to connect the plowing device to the accessory interface of the firefighting vehicle, and
as the first equipment, a plow blade constructed and arranged to plow material;
wherein the plow blade defines a front plowing surface to contact the material; and
wherein the receiver of the first vehicle accessory is disposed between the firefighting vehicle body and the front plowing surface.

12. The firefighting vehicle of claim 11, wherein the receiver is accessible by the first vehicle accessory through an opening in the front plowing surface.

13. The firefighting vehicle of claim 12, wherein the front plowing surface defined by the plow blade has a face height and a face width; and
wherein the opening is a hole in the plow blade which is centrally positioned relative to the face height and the face width.

14. The firefighting vehicle of claim 13, wherein the accessory interface of the firefighting vehicle is constructed and arranged to selectively raise and lower the plowing device relative to the firefighting vehicle body.

15. A vehicle accessory assembly, comprising:
a first vehicle accessory including:
a vehicle interface constructed and arranged to attach to a vehicle,
first equipment coupled with the vehicle interface, the first equipment being constructed and arranged to operate while the first vehicle accessory is attached to the vehicle, and
a receiver coupled with at least one of the equipment and the vehicle interface, the receiver being constructed and arranged to support attachment of another vehicle accessory; and
a second vehicle accessory including:
an insert constructed and arranged to engage with the receiver of the first vehicle accessory, and
second equipment coupled with the vehicle interface, the second equipment being constructed and arranged to operate while the insert of the second vehicle accessory engages with the receiver of the first vehicle accessory.

16. The vehicle accessory assembly of claim 15 wherein one of the first equipment and the second equipment is a winch device constructed and arranged to pull loads.

17. The vehicle accessory assembly of claim 16 wherein the other of the first equipment and the second equipment is a plow device constructed and arranged to plow material.

18. The vehicle accessory assembly of claim 15 wherein the first vehicle accessory is a plowing device, and the first equipment includes a plow blade constructed and arranged to plow material.

19. The vehicle accessory assembly of claim 18 wherein the receiver of the first vehicle accessory is accessible through a hole in the plow blade to enable the second vehicle accessory to attach to the first vehicle accessory.

20. The vehicle accessory assembly of claim 15 wherein the first vehicle accessory further includes a pin constructed and arranged to pass through a set of holes in the receiver to enable locking of the second vehicle accessory to the first vehicle accessory when the insert of the second vehicle accessory engages with the receiver and the pin is inserted through the set of holes.
